(19) United States
(12) Patent Application Publication
(10) Pub. No.: US 2025/0167850 A1
(43) Pub. Date: May 22, 2025

(54) CONFIGURING A CHANNEL STATE INFORMATION REPORT

(71) Applicant: Lenovo (Singapore) Pte. Ltd., New Tech Park (SG)

(72) Inventors: Ahmed Hindy, Aurora, IL (US); Vijay Nangia, Woodridge, IL (US)

(21) Appl. No.: 18/838,977

(22) PCT Filed: Feb. 16, 2023
(86) PCT No.: PCT/IB2023/051419

§ 371 Date: Aug. 15, 2024

Related U.S. Application Data
(60) Provisional application No. 63/311,395, filed on Feb. 17, 2022.

(51) Int. Cl. H04B 7/06; H04B 7/0456

(52) U.S. Cl. CPC H04B 7/0626; H04B 7/0456; H04B 7/06968

(57) ABSTRACT

Apparatuses, methods, and systems are disclosed for configuring a channel state information (“CSI”) report. One method includes receiving, at a user equipment (“UE”), a CSI reporting setting. The method includes receiving a plurality of non-zero power (“NZP”) CSI reference signal (RS) (“CSI-RS”) resources for channel measurement (“CMR”). The method includes transmitting a CSI report based on the received NZP CSI-RS resources. The method includes receiving downlink control information (“DCI”) for scheduling a physical downlink shared channel (“PDSCH”). The DCI includes a transmission configuration indicator (“TCI”) field, a TCI state codepoint corresponding to the TCI field comprises a plurality of TCI states, and quasi-co-location (“QCL”) information associated with each TCI state corresponds to a demodulation reference signal (“DMRS”) for PDSCH and a distinct set of NZP CSI-RS resources.

### FIELD

The subject matter disclosed herein relates generally to wireless communications and more particularly relates to configuring a channel state information (“CSI”) report.

### BACKGROUND

In certain wireless communications networks, multiple transmission and reception points (“TRPs”) may be used. In such networks, CSI may be transmitted by the multiple TRPs.

### BRIEF SUMMARY

Methods for configuring a CSI report are disclosed. Apparatuses and systems also perform the functions of the methods. One embodiment of a method includes receiving, at a user equipment (“UE”), a CSI reporting setting. In some embodiments, the method includes receiving a plurality of non-zero power (“NZP”) CSI reference signal (“RS”) (“CSI-RS”) resources for channel measurement (“CMR”). In certain embodiments, the method includes transmitting a CSI report based on the received NZP CSI-RS resources. In various embodiments, the method includes receiving downlink control information (“DCI”) for scheduling a physical downlink shared channel (“PDSCH”). The DCI includes a transmission configuration indicator (“TCI”) field, a TCI state codepoint corresponding to the TCI field comprises a plurality of TCI states, and quasi-co-location (“QCL”) information associated with each TCI state corresponds to a demodulation reference signal (“DMRS”) for PDSCH and a distinct set of NZP CSI-RS resources.

One apparatus for configuring a CSI report includes a UE. In some embodiments, the apparatus includes a receiver that: receives a CSI reporting setting; and receives a plurality of NZP CSI-RS resources for CMR. In various embodiments, the apparatus includes a transmitter that transmits a CSI report based on the received NZP CSI-RS resources. The receiver receives DCI for scheduling a PDSCH. The DCI includes a TCI field, a TCI state codepoint corresponding to the TCI field comprises a plurality of TCI states, and QCL information associated with each TCI state corresponds to a DMRS for PDSCH and a distinct set of NZP CSI-RS resources.

Another embodiment of a method for configuring a CSI report includes transmitting, from at least one network device, a CSI reporting setting. In some embodiments, the method includes transmitting a plurality of NZP CSI-RS resources for CMR. In certain embodiments, the method includes receiving a CSI report based on the received NZP CSI-RS resources. In various embodiments, the method includes transmitting DCI for scheduling a PDSCH. The DCI includes a TCI field, a TCI state codepoint corresponding to the TCI field comprises a plurality of TCI states, and QCL information associated with each TCI state corresponds to a DMRS for PDSCH and a distinct set of NZP CSI-RS resources.

Another apparatus for configuring a CSI report includes at least one network device. In some embodiments, the apparatus includes a transmitter that: transmits a CSI reporting setting; and transmits a plurality of NZP CSI-RS resources for CMR. In various embodiments, the apparatus includes a receiver that receives a CSI report based on the received NZP CSI-RS resources. The transmitter transmits DCI for scheduling a PDSCH. The DCI includes a TCI field, a TCI state codepoint corresponding to the TCI field includes a plurality of TCI states, and QCL information associated with each TCI state corresponds to a DMRS for PDSCH and a distinct set of NZP CSI-RS resources.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring a CSI report;

FIG. 2 is a schematic block diagram illustrating one embodiment of an apparatus that may be used for configuring a CSI report;

FIG. 3 is a schematic block diagram illustrating one embodiment of an apparatus that may be used for configuring a CSI report;

FIG. 4 is a schematic block diagram illustrating one embodiment of a system for configuring a CSI report;

FIG. 5 is a flow chart diagram illustrating one embodiment of a method for configuring a CSI report; and

FIG. 6 is a flow chart diagram illustrating another embodiment of a method for configuring a CSI report.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

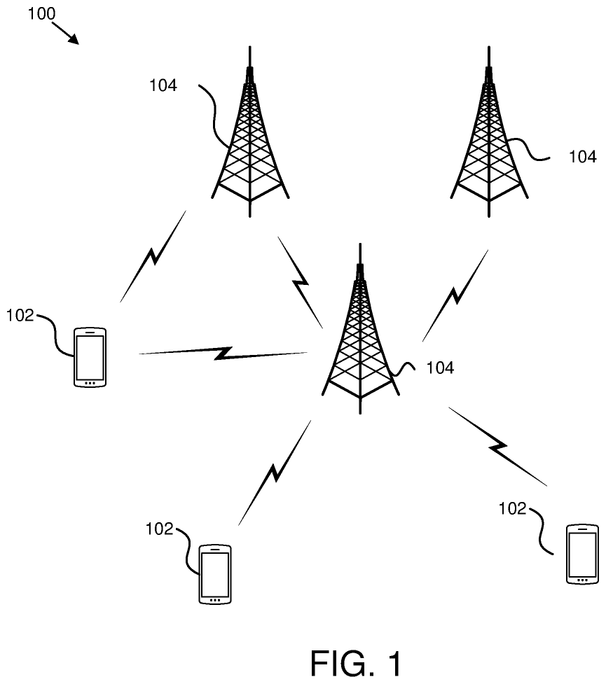

FIG. 1 depicts an embodiment of a wireless communication system 100 for configuring a CSI report. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-third generation partnership project (“3GPP”) gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an orthogonal frequency division multiplexing (“OFDM”) modulation scheme on the downlink (“DL”) and the remote units 102 transmit on the uplink (“UL”) using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive, at a UE, a CSI reporting setting. In some embodiments, the remote unit 102 may receive a plurality of NZP CSI-RS resources for CMR. In certain embodiments, the remote unit 102 may transmit a CSI report based on the received NZP CSI-RS resources. In various embodiments, the remote unit 102 may receive DCI for scheduling a PDSCH. The DCI includes a TCI field, a TCI state codepoint corresponding to the TCI field comprises a plurality of TCI states, and QCL information associated with each TCI state corresponds to a DMRS for PDSCH and a distinct set of NZP CSI-RS resources. Accordingly, the remote unit 102 may be used for configuring a CSI report.

In certain embodiments, a network unit 104 may transmit, from at least one network device, a CSI reporting setting. In some embodiments, the network unit 104 may transmit a plurality of NZP CSI-RS resources for CMR. In certain embodiments, the network unit 104 may receive a CSI report based on the received NZP CSI-RS resources. In various embodiments, the network unit 104 may transmit DCI for scheduling a PDSCH. The DCI includes a TCI field, a TCI state codepoint corresponding to the TCI field comprises a plurality of TCI states, and QCL information associated with each TCI state corresponds to a DMRS for PDSCH and a distinct set of NZP CSI-RS resources. Accordingly, the network unit 104 may be used for configuring a CSI report.

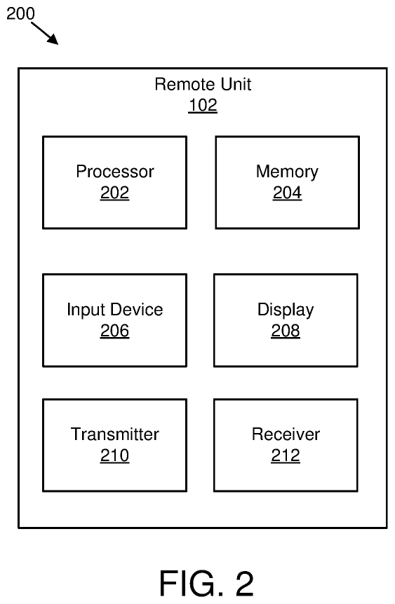

FIG. 2 depicts one embodiment of an apparatus 200 that may be used for configuring a CSI report. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212: receives a CSI reporting setting; and receives a plurality of NZP CSI-RS resources for CMR. In various embodiments, the transmitter 210 transmits a CSI report based on the received NZP CSI-RS resources. The receiver 212 receives DCI for scheduling a PDSCH. The DCI includes a TCI field, a TCI state codepoint corresponding to the TCI field comprises a plurality of TCI states, and QCL information associated with each TCI state corresponds to a DMRS for PDSCH and a distinct set of NZP CSI-RS resources.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

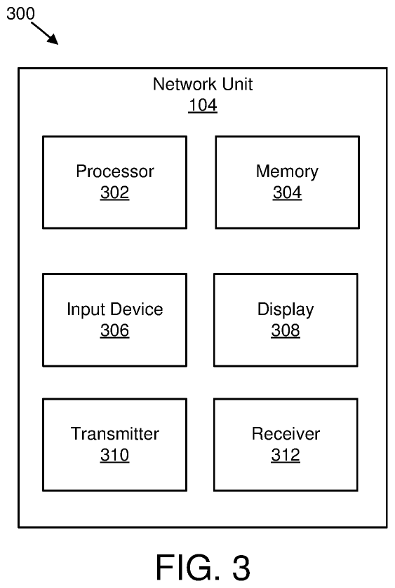

FIG. 3 depicts one embodiment of an apparatus 300 that may be used for configuring a CSI report. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310: transmits a CSI reporting setting; and transmits a plurality of NZP CSI-RS resources for CMR. In various embodiments, the receiver 312 receives a CSI report based on the received NZP CSI-RS resources. The transmitter 310 transmits DCI for scheduling a PDSCH. The DCI includes a TCI field, a TCI state codepoint corresponding to the TCI field includes a plurality of TCI states, and QCL information associated with each TCI state corresponds to a DMRS for PDSCH and a distinct set of NZP CSI-RS resources.

In certain embodiments, such as for 3GPP new radio (“NR”), multiple panel, TRP, and/or remote radio head (“RRH”) nodes within a cell may communicate simultaneously with one UE to enhance coverage, throughput, and reliability. The panels, TRPs, and/or RRHs may not be co-located (e.g., they may be placed in remote locations). Communicating with a same UE via multiple nodes may come at the expense of excessive control signaling between a network side and the UE side, so as to communicate the best transmission configuration (e.g., whether to support multi-point transmission, and if so, which panel would operate simultaneously) in addition to a possibly super-linear increase in the amount of CSI feedback reported from the UE to the network, since a distinct codebook may be needed for each point. For codebooks with high resolution, a number of precoder matrix indicator (“PMI”) bits fed back from the UE in the gNB via uplink control information (“UCI”) may be very large (e.g., >1000 bits at large bandwidth), even for a single-point transmission. The purpose of multi-panel transmission may be to improve spectral efficiency as well as reliability and robustness of a connection in different scenarios, and may cover both ideal and nonideal backhaul. For increasing reliability using multi-panel transmission, ultra-reliable low-latency communication (“URLLC”) under multi-panel transmission may be used, where a UE can be served by multiple TRPs forming a coordination cluster, possibly connected to a central processing unit.

In some embodiments, the presence of K panels may trigger up to 2K−1 possible transmission hypotheses. For instance, at K=4, the following 15 transmission hypotheses may be possible: 1) 4 single-TRP transmission hypotheses for TRPs 1, 2, 3, 4; 2) 6 double-TRP transmission hypotheses for TRP pairs {1,2}, {1,3}, {1,4}, {2,3}, {2,4}, {3,4}; 3) 4 triple-TRP transmission hypotheses for TRP triplets {1,2,3}, {1,2,4}, {1,3,4}, {2,3,4}; and 4) 1 quadruple TRP hypothesis for TRP quadruplet {1,2,3,4}.

In various embodiments, a multi-TRP physical downlink shared channel (“PDSCH”) transmission from two TRPs is represented with two 2 transmission configuration indicator (“TCI”) states indicated within a TCI codepoint of downlink control information (“DCI”) for scheduling PDSCH, wherein each TRP is associated with a distinct code division multiplexing (“CDM”) group of a demodulation reference signal (“DMRS”). For K>2 TRPs, it may be challenging since additional signaling to identify an association of DMRS ports with corresponding CSI reference signal (“RS”) (“CSI-RS”) resources may be needed.

In certain embodiments, for the purpose of coherent joint transmission support in NR, there may be: 1) coherent joint transmission from K≥2 TRPs corresponding to a single TCI state, with the K TRPs associated with a distinct CSI-RS port group with distinct CDM groups, within a common CSI-RS resource—an indication of a selected subset of K′≤K TRPs is fed back, wherein the K′ TRPs can be modeled with a common average delay and/or Doppler shift; 2) coherent joint transmission from K≥2 TRPs corresponding to K TCI states, with each of the K TRPs associated with a distinct CSI-RS resource—a mapping of the CSI-RS resources with the DMRS ports is introduced, with different embodiments corresponding to a mapping via a rule, or via radio resource control (“RRC”) signaling may be used; and/or 3) coherent joint transmission from K≥2 TRPs corresponding to 2 TCI states, with a first K/2 TRPs are associated with a first of the two TCI states and a second K/2 TRPs are associated with a second of the two TCI states—this may be applicable to a scenario with pairwise coherence between TRPs, wherein up to two TRPs constitute a TRP group that can transmit a common set of layers, and wherein different TRP groups transmit distinct sets of layers of a PDSCH.

In some embodiments there may be: 1) multi-panel codebook: the codebook design may be based on an inherent assumption that both TRPs are co-located; 2) multi-panel CSI framework: CSI enhancements for multi-TRP and multi-panel transmission may be used with enhancements on CSI reporting configurations and CSI-RS configuration—CSI framework may not be limited to non-coherent joint transmission (“NCJT”) with two TRPs, wherein each TRP transmits a distinct set of layers; and/or 3) a TCI state indication: multi-TRP transmission of PDSCH is indicated via two TCI states corresponding to the two TRPs, wherein different TRPs are associated with different CDM groups in the case of space division multiplexing (“SDM”) Scheme A.

In various embodiments, a gNB is equipped with a 2D antenna array with N1, N2 antenna ports per polarization placed horizontally and vertically and communication occurs over N3 PMI sub-bands. A PMI subband includes a set of resource blocks, each resource block consisting of a set of subcarriers. In such case, 2N₁N₂ CSI-RS ports are used to enable DL channel estimation with high resolution for NR Type-II codebook. To reduce the UL feedback overhead, a discrete Fourier transform (“DFT”) based CSI compression of the spatial domain is applied to L dimensions per polarization, where L<N₁N₂. In the sequel, the indices of the 2L dimensions are referred as spatial domain (“SD”) basis indices. The magnitude and phase values of the linear combination coefficients for each sub-band are fed back to the gNB as part of the CSI report. The 2N₁N₂×N₃ codebook per layer takes on the form: W=W₁W₂, where W1 is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N1N2×L matrix with columns drawn from a 2D oversampled DFT matrix, as follows:

$${u}_{m} = [ 1 {e}^{j \frac{2 π m}{{O}_{2} {N}_{2}}} … {e}^{j \frac{2 π m ( {N}_{2} - 1 )}{{O}_{2} {N}_{2}}} ] ,$$

$${v}_{l , m} = {[ {u}_{m} {e}^{j \frac{2 π l}{{O}_{1} {N}_{1}}} {u}_{m} … {e}^{j \frac{2 π l ( {N}_{1} - 1 )}{{O}_{1} {N}_{1}}} {u}_{m} ]}^{T} ,$$

$$B = [ {v}_{{l}_{0} , {m}_{0}} {v}_{{l}_{1} , {m}_{1}} … {v}_{{l}_{L - 1} , {m}_{L - 1}} ] ,$$

$${l}_{i} = {O}_{12} {n}_{1}^{( i )} + {q}_{1} , 0 \leq {n}_{1}^{( i )} < {N}_{1} , 0 \leq {q}_{1} < {O}_{1} - 1 ,$$

mᵢ=O₂n₂⁽ⁱ⁾+q₂, 0≤n₂⁽ⁱ⁾<N₂, 0≤q₂<O₂−1, where the superscript T denotes a matrix transposition operation. O₁ and O₂ oversampling factors are assumed for the 2D DFT matrix from which matrix B is drawn. W₁ is common across all layers. W₂ is a 2L×N₃ matrix, where the i^{th} column corresponds to the linear combination coefficients of the 2L beams in the ith sub-band. Only the indices of the L selected columns of B are reported, along with the oversampling index taking on O1O2 values. W₂ is independent for different layers.

In certain embodiments, for Type-II Port selection codebook, only K (e.g., where K≤2N₁N₂) beamformed CSI-RS ports are used in DL transmission to reduce complexity. The K×N₃ codebook matrix per layer takes on the form: W=W₁^{PS}W₂. Here, W₂ follows the same structure as an NR Type-II Codebook and is layer specific. W₁^{PS} is a K×2L block-diagonal matrix with two identical diagonal blocks, i.e.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows:

E=[e_{mod(m}_{_{PS}}_{d}_{_{PS}}_{,K/2)}^{(K/2)} e_{mod(m}_{_{PS}}_{d}_{_{PS}}_{+1,K/2)}^{(K/2)} . . . e_{mod(m}_{_{PS}}_{d}_{_{PS}}_{+L-1,K/2)}^{(K/2)}], where eᵢ^{(K)} is a standard unit vector with a 1 at the ith location. Here d_{PS} is an RRC parameter which takes on the values {1,2,3,4} under the condition d_{PS}≤min(K/2, L), whereas m_{PS} takes on the values

$$\{ 0 , … , ⌈ \frac{K}{2 {d}_{PS}} ⌉ - 1 \}$$

and is reported as part of the UL CSI feedback overhead. W₁ is common across all layers. For K=16, L=4 and dPS=1, the 8 possible realizations of E corresponding to m_{PS}={0,1, . . . , 7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

In some embodiments, NR Type-I codebook is a baseline codebook for NR, with a variety of configurations. The most common utility of Type-I codebook is a special case of NR Type-II codebook with L=1 for RI=1, 2, wherein a phase coupling value is reported for each sub-band, i.e., W₂ is 2×N₃, with the first row equal to [1, 1, . . . , 1] and the second row equal to [e^{j2πØ}^{₀}, . . . , e^{j2πØ}^{_{N3-1}}]. Under specific configurations, ϕ₀=ϕ₁ . . . =ϕ, i.e., wideband reporting. For RI>2 different beams are used for each pair of layers. NR Type-I codebook may be depicted as a low-resolution version of an NR Type-II codebook with spatial beam selection per layer-pair and phase combining only.

In various embodiments, a gNB is equipped with a two-dimensional (“2D”) antenna array with N₁, N₂ antenna ports per polarization placed horizontally and vertically and communication occurs over N₃ PMI sub-bands. A PMI sub-band may include a set of resource blocks, each resource block consisting of a set of subcarriers. In such case, 2N₁N₂N₃ CSI-RS ports are utilized to enable DL channel estimation with high resolution for NR Type-II codebook. To reduce the UL feedback overhead, a DFT-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form: W=W₁\tilde{W}₂W_{f}^{H}, where W₁ is a 2N₁N₂×2L block-diagonal matrix (L<N1N2) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ 1 {e}^{j \frac{2 π m}{{O}_{2} {N}_{2}}} … {e}^{j \frac{2 π m ( {N}_{2} - 1 )}{{O}_{2} {N}_{2}}} ] ,$$

$${v}_{l , m} = {[ {u}_{m} {e}^{j \frac{2 π l}{{O}_{1} {N}_{1}}} {u}_{m} … {e}^{j \frac{2 π l ( {N}_{1} - 1 )}{{O}_{1} {N}_{1}}} {u}_{m} ]}^{T} ,$$

$$B = [ {v}_{{l}_{0} , {m}_{0}} {v}_{{l}_{1} , {m}_{1}} … {v}_{{l}_{L - 1} , {m}_{L - 1}} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

mᵢ=O₂n₂⁽ⁱ⁾+q₂, 0≤n₂⁽ⁱ⁾<N₂, 0≤q₂<O₂−1, where the superscript T denotes a matrix transposition operation. O₁ and O₂ oversampling factors are assumed for the 2D DFT matrix from which matrix B is drawn. W₁ may be common across all layers. W_{f} is an N₃×M matrix (M<N₃) with columns selected from a critically sampled size-N₃ DFT matrix, as follows:

$$\begin{matrix}{W}_{f} = [ {f}_{{k}_{0}} {f}_{{k}_{1}} … {f}_{{k}_{{M}^{′} - 1}} ] , 0 \leq {k}_{i} < {N}_{3} - 1 , \\ {f}_{k} = [ 1 {e}^{- j \frac{2 π k}{{N}_{3}}} … {e}^{{- j \frac{2 π k ( {N}_{3} - 1 )}{{N}_{3}} ]}^{T}} .\end{matrix}$$

In certain embodiments, only the indices of the L selected columns of B are reported, along with the oversampling index taking on O₁O₂ values. Similarly, for W_{f}, only the indices of the M selected columns out of the predefined size-N₃ DFT matrix are reported. In the sequel, the indices of the M dimensions are referred as the selected frequency domain (“FD”) basis indices. Hence, L and M represent the equivalent spatial and frequency dimensions after compression, respectively. Finally, the 2L×M matrix \tilde{W}₂ represents the linear combination coefficients (“LCCs”) of the spatial and frequency DFT-basis vectors. Both \tilde{W}₂, Wf are selected independent for different layers. Magnitude and phase values of an approximately β fraction of the 2LM available coefficients are reported to the gNB (β<1) as part of the CSI report. Coefficients with zero magnitude are indicated via a per-layer bitmap. Since all coefficients reported within a layer are normalized with respect to the coefficient with the largest magnitude (e.g., strongest coefficient), the relative value of that coefficient is set to unity, and no magnitude or phase information is explicitly reported for this coefficient. Only an indication of the index of the strongest coefficient per layer is reported. Hence, for a single-layer transmission, magnitude and phase values of a maximum of [2βLM]−1 coefficients (e.g., along with the indices of selected L, M DFT vectors) are reported per layer, leading to significant reduction in CSI report size, compared with reporting 2N1N2×N3−1 coefficients' information.

In some embodiments, for Type-II port selection codebook, only K (e.g., where K≤2N₁N₂) beamformed CSI-RS ports are used in DL transmission to reduce complexity. The K×N₃ codebook matrix per layer takes on the form: W=W₁^{PS}\tilde{W}₂W_{f}^{H}. Here, \tilde{W}₂ and W₃ follow the same structure as an NR Type-II codebook, where both are layer specific. The matrix W₁^{PS} is a K×2L block-diagonal matrix with the same structure as that in an NR Type-II port selection codebook.

In various embodiments, a codebook report is partitioned into two parts based on a priority of information reported. Each part may be encoded separately (e.g., Part 1 has a possibly higher code rate).

In certain embodiments, a content of a CSI report may include 1) Part 1: rank indicator (“RI”)+channel quality indicator (“CQI”)+total number of coefficients; and 2) Part 2: SD basis indicator+FD basis indicator and/or layer+bitmap and/or layer+coefficient amplitude information and/or layer+coefficient phase information and/or layer+strongest coefficient indicator and/or layer. Furthermore, Part 2 CSI may be decomposed into sub-parts each with a different priority (e.g., higher priority information listed first). Such partitioning may be required to allow dynamic reporting size for codebook based on available resources in the uplink phase.

In some embodiments, a Type-II codebook is based on aperiodic CSI reporting, and only reported in a physical uplink shared channel (“PUSCH”) via DCI triggering (e.g., one exception). Type-I codebook may be based on periodic CSI reporting (e.g., physical uplink control channel (“PUCCH”)) or semi-persistent CSI reporting (e.g., PUSCH or PUCCH) or aperiodic reporting (e.g., PUSCH).

In various embodiments, there may be priority reporting for Part 2 CSI. Multiple (e.g., up to NRep) CSI reports may be transmitted, whose priority are shown in Table 1.

TABLE 1
CSI Reports priority ordering

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report
N_{Rep}, if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

In certain embodiments, a priority of N_{Rep} CSI reports may be based on the following: 1) a CSI report corresponding to one CSI reporting configuration for one cell may have higher priority compared with another CSI report corresponding to one other CSI reporting configuration for the same cell; 2) CSI reports intended to one cell may have higher priority compared with other CSI reports intended to another cell; 3) CSI reports may have higher priority based on the CSI report content (e.g., CSI reports carrying layer 1 (“L1”) reference signal received power (“RSRP”) (“L1-RSRP”) information have higher priority); and 4) CSI reports may have higher priority based on their type (e.g., whether the CSI report is aperiodic, semi-persistent or periodic, and whether the report is sent via PUSCH or PUCCH) may impact the priority of the CSI report.

In some embodiments, CSI reports may be prioritized as follows, where CSI reports with lower IDs have higher priority:
Pri_{iCSI}(y, k, c, s)=2·N_{cells}·Mₛ·y+N_{cells}·Mₛ·k+Mₛ·c+s, s: CSI reporting configuration index; Mₛ: maximum number of CSI reporting configurations; c: cell index; N_{cells}: number of serving cells; k: 0 for CSI reports carrying L1-RSRP or L1 signal-to-interference-and-noise ratio (“SINR”) (“L1-SINR”), 1 otherwise; y: 0 for aperiodic reports, 1 for semi-persistent reports on PUSCH, 2 for semi-persistent reports on PUCCH, 3 for periodic reports.

In various embodiments, there may be an UCI bit sequence generation. The bitwidth for RI, layer indicator (“LI”), CQI, and/or CSI-RS resource indicator (“CRI”) of codebookType=typeI-SinglePanel is provided in Table 2.

TABLE 2
RI, LI, CQI, and CRI of Type-I single-panel codebook

| | Bitwidth | | | | |
|---|---|---|---|---|---|
| | 1 antenna | 2 antenna | 4 antenna | >4 antenna ports | |
| Field | port | ports | ports | Rank1~4 | Rank5~8 |
| Rank Indicator | 0 | min(1, ┌log₂ n_{RI}┐) | min(2, ┌log₂ n_{RI}┐) | ┌log₂ n_{RI}┐ | ┌log₂ n_{RI}┐ |
| Layer Indicator | 0 | ┌log₂ υ┐ | min(2, ┌log₂ υ┐) | min(2, ┌log₂ υ┐) | min(2, ┌log₂ υ┐) |
| Wide-band CQI for the | 4 | 4 | 4 | 4 | 4 |
| first transport block | | | | | |
| (“TB”) | | | | | |
| Wideband CQI for the | 0 | 0 | 0 | 0 | 4 |
| second TB | | | | | |
| Subband differential | 2 | 2 | 2 | 2 | 2 |
| CQI for the first TB | | | | | |
| Subband differential | 0 | 0 | 0 | 0 | 2 |
| CQI for the second TB | | | | | |
| CRI | ┌log₂(Kₛ^{CSI-RS})┐ | ┌log₂(Kₛ^{CSI-RS})┐ | ┌log₂(Kₛ^{CSI-RS})┐ | ┌log₂(Kₛ^{CSI-RS})┐ | ┌log₂(Kₛ^{CSI-RS})┐ |

TABLE 3
Mapping order of CSI fields of one CSI report
with wideband PMI and wideband CQI

| CSI report | |
|---|---|
| number | CSI fields |
| CSI report #n | CRI, if reported |
| | Rank Indicator, if reported |
| | Layer Indicator, if reported |
| | Zero padding bits O_{P}, if needed |
| | PMI wideband information fields X₁, from |
| | left to right, if reported |
| | PMI wideband information fields X₂, from left to right, |
| | or codebook index for 2 antenna ports, if reported |
| | Wideband CQI for the first TB, if reported |
| | Wideband CQI for the second TB, if reported |

In Table 2, n_{RI}, v and Kₛ^{CSI-RS} are the number of allowed rank indicator values, the value of the rank and the number of CSI-RS resources in the corresponding resource set, respectively. The values of the rank indicator field are mapped to allowed rank indicator values with increasing order, where ‘0’ is mapped to the smallest allowed rank indicator value.

TABLE 4
Mapping order of CSI Part 1 fields of a CSI
report, with sub-band PMI or sub-band CQI

| CSI report number | CSI fields |
|---|---|
| CSI report #n | CRI, if reported |
| CSI part 1 | Rank Indicator, if reported |
| | Wideband CQI for the first TB, if reported |
| | Subband differential CQI for the first TB with |
| | increasing order of subband number, if reported |
| | Indicator of the number of non-zero wideband |
| | amplitude coefficients M₀ for layer 0, if reported |
| | Indicator of the number of non-zero wideband |
| | amplitude coefficients M₁ for layer 1 (if the rank |
| | according to the reported RI is equal to one, this |
| | field is set to all zeros), if 2-layer PMI reporting |
| | is allowed according to the rank restriction and |
| | if reported |

Note:
Subbands for given CSI report n indicated by the higher layer parameter csi-ReportingBand are numbered continuously in the increasing order with the lowest subband of csi-ReportingBand as subband 0.

TABLE 5
Mapping order of wideband CSI Part 2 fields of
a CSI report with sub-band PMI or sub-band CQI

| CSI report | |
|---|---|
| number | CSI fields |
| CSI report #n | Wideband CQI for the second TB, if present and reported |
| CSI part 2 | Layer Indicator, if reported |
| wideband | PMI wideband information fields X₁, from left to right, |
| | if reported |
| | PMI wideband information fields X₂ , from left |
| | to right, or codebook index for 2 antenna ports, |
| | if pmi-FormatIndicator = widebandPMI and if reported |

TABLE 6
Mapping order of sub-band CSI Part 2 fields of
a CSI report with sub-band PMI or sub-band CQI

| | |
|---|---|
| CSI report #n | Subband differential CQI for the second TB of all even subbands with increasing order |
| Part 2 | of subband number, if cqi-FormatIndicator = subbandCQI and if reported |
| subband | PMI subband information fields X₂ of all even subbands with increasing order of |
| | subband number, from left to right, or codebook index for 2 antenna ports of all even |
| | subbands with increasing order of subband number, if pmi-FormatIndicator = |
| | subbandPMI and if reported |
| | Subband differential CQI for the second TB of all odd subbands with increasing order |
| | of subband number, if cqi-FormatIndicator = subbandCQI and if reported |
| | PMI subband information fields X₂ of all odd subbands with increasing order of |
| | subband number, from left to right, or codebook index for 2 antenna ports of all odd |
| | subbands with increasing order of subband number, if pmi-FormatIndicator = |
| | subbandPMI and if reported |

In various embodiments, sub-bands for given CSI report n indicated by the higher layer parameter csi-ReportingBand are numbered continuously in the increasing order with the lowest subband of csi-ReportingBand as subband 0.

TABLE 7
Mapping order of CSI Part 2 fields of a CSI report with ‘typeII-r16’ or ‘typeII-
PortSelection-r16’ codebook

| CSI report | |
|---|---|
| number | CSI fields |
| CSI report #n | PMI fields X₁, from left to right, if reported |
| CSI part 2, | |
| group 0 | |
| CSI report #n | The following PMI fields X₂, from left to right: {i_{2,3,l}: l = 1, ... , υ}, {i_{1,5}, {i_{1,6,l}: |
| CSI part 2, | l = 1, ... , υ} |
| group 1 | $and ( ⌈ \frac{{K}^{N Z}}{2} ⌉ - υ ) \times 3 highest priority bits of$ |
| | {i_{2,4,l}: l = 1, ... , υ}, (┌K^{NZ}/2┐ − υ) × 4 highest priority bits of {i_{2,5,l}: l = 1, ... , υ} |
| | and v * 2LM_{υ} − └K^{NZ}/2┘ highest priority bits of{i_{1,7,l}: l = 1, ... , υ}, in decreasing |
| | order of priority based on function Pri(l, i, f), if reported |
| CSI report #n | The following PMI fields X₂, from left to right: └K^{NZ}/2┘ × 3 lowest priority bits of |
| CSI part 2, | {i_{2,4,1}: 1 = 1, ... , υ}, └K^{NZ}/2┘ × 4 lowest priority bits of {i_{2,5,l}: l = 1, ... , υ} and └K^{NZ}/2┘ |
| group 2 | lowest priority bits of {i_{1,7,l}: l = 1, ... , υ}, in decreasing order of priority based on |
| | function Pri(l, i, f), if reported |

In certain embodiments, a CSI report content in UCI, whether on PUCCH or PUSCH, is provided. A rank indicator (“RI”), if reported, has a bitwidth of min(┌log₂ Nₚₒᵣₜₛ┐,┌log₂ n_{RI}┐), where Nₚₒᵣₜₛ, n_{RI} represent the number of antenna ports and the L number of allowed rank indicator values, respectively. On the other hand, the CR and the synchronization signal block resource indicator (“SSBRI”) each have bitwidths of ┌log₂ Kₛ^{CSI-RS}┐, ┌log₂ Kₛ^{SSB}┐, respectively, where Kₛ^{CSI-RS} is the number of CSI-RS resources in the corresponding resource set, and Kₛ^{SSB} is the configured number of synchronization signal (“SS”) physical broadcast channel (“PBCH”) (“SS/PBCH”) blocks in the corresponding resource set for reporting ‘ssb-Index-RSRP’. The mapping order of CSI fields of one CSI report with wideband PMI and wideband CQI on PUCCH is depicted in Table 8.

TABLE 8
Mapping order of CSI fields of one CSI report
with wideband PMI and CQI on PUCCH

| CSI report | |
|---|---|
| number | CSI fields |
| CSI report #n | CRI, if reported |
| | Rank Indicator, if reported |
| | Layer Indicator, if reported |
| | Zero padding bits, if needed |
| | PMI wideband information fields, if reported |
| | PMI wideband information, if reported |
| | Wideband CQI for the first Transport Block, |
| | if reported |
| | Wideband CQI for the second Transport Block, |
| | if reported |

In some embodiments: 1) the following notions are used interchangeably: panel, set of antennas, set of antenna ports, uniform linear array, cell, node, radio head, communication (e.g., signals and/or channels) associated with a control resource set (“CORESET”) pool, communication associated with a TCI state from a transmission configuration comprising at least two TCI states; 2) the codebook type used is arbitrary (e.g., flexibility for use of different codebook types such as Type-II codebook, Type-II codebook, etc.); and/or 3) the network communicates with the UE in single user (“SU”) multiple-input multiple-output (“MIMO”) (“SU-MIMO”) mode (e.g., DMRS ports for PDSCH transmission corresponding to a TRP are associated with at most one UE). It should be noted that in various embodiments, one or more elements or features from one or more of the described embodiments may be combined.

In various embodiments, there may be a single TCI state corresponding to coherent joint transmission (“CJT”). In such embodiments, a UE configured with CJT transmission is associated with at least one non-zero power (“NZP”) CSI-RS resource associated with the TCI state indicated in the TCI codepoint. The CSI-RS resource corresponding to channel measurement from the K TRPs is associated with a DMRS for PDSCH in a form of a TCI state, wherein the TCI state is indicated via a TCI codepoint in a DCI that schedules PDSCH transmission (e.g., DCI Format 1_1 or DCI Format 1_2).

In certain embodiments, a scheme may be associated with a new repetition scheme within a repetition scheme configuration, wherein the repetition scheme configuration corresponds to a PDSCH configuration. In one example, the new repetition scheme is in a form of a space-division multiplexing (“SDM”) scheme.

In a first set of embodiments, there may be CSI-RS resource allocation for K TRPs. Each of the multiple TRPs that jointly transmit to the TRP are associated with a distinct and/or exclusive group of CSI-RS units within a CSI-RS super unit (e.g., K CSI-RS units).

In a first embodiment of the first set of embodiments, each of the multiple TRPs that jointly transmit to the TRP are associated with a distinct group of CSI-RS ports within a same NZP CSI-RS resource. In a first example, an NZP CSI-RS resource including N CSI-RS ports is decomposed into K groups of N/K exclusive CSI-RS ports, wherein each CSI-RS port group is associated with a distinct TRP. In a second example, a CSI-RS resource including N CSI-RS ports is decomposed into K groups of n₁, n₂, . . . , n_{K} exclusive CSI-RS ports, wherein n₁+n₂+ . . . +n_{K}=N. The CSI-RS port grouping is based on one or more of a pre-defined rule, and higher-layer signaling (e.g., based on medium access control (“MAC”) control element (“CE”) or RRC signaling). In a third example, each CSI-RS port group corresponds to a different CDM group.

In a second embodiment of the first set of embodiments, a number of CSI-RS port groups is no less than a number of CDM groups corresponding to the CSI-RS resource.

In a third embodiment of the first set of embodiments, each of the multiple TRPs that jointly transmit to the TRP are associated with a distinct NZP CSI-RS resource of a common NZP CSI-RS resource set (e.g., a total of K NZP CSI-RS resources within a same NZP CSI-RS resource set are allocated with the TCI state). In this embodiment, an NZP CSI-RS resource ID codepoint may correspond to more than one NZP CSI-RS resource.

In a second set of embodiments, there may be a CSI reporting configuration. In such embodiments, a CSI reporting configuration corresponding to CT includes the at least one NZP CSI-RS resource, wherein the at least one NZP CSI-RS resource is configured for channel measurement and reporting. The CSI reporting configuration may configure the UE to report up to K PMIs, wherein each PMI corresponds to a distinct CSI-RS unit.

In a first embodiment of the second set of embodiments, the CSI reporting configuration triggers the UE to report a CSI report comprising up to K PMI, one corresponding to each TRP, wherein each PMI includes a same number of layers indicated via a one RI corresponding to a common set of PDSCH layers, and up to two CQIs are reported; one CQI is reported if the value indicated in the RI is no more than 4, and two CQIs otherwise. Up to 2 LI are reported, one for each codeword corresponding to a CQI.

In a second embodiment of the second set of embodiments, the CSI reporting configuration triggers the UE to report a CSI report including up to K PMI, one corresponding to each TRP, wherein each PMI includes a distinct number of layers indicated via up to K RIs corresponding to distinct PDSCH layers. In a first example, each PMI is associated with a distinct RI (e.g., one-to-one mapping between RI and PMI). In a second example, up to two PMI share a same RI (e.g., a first and a second of the K PMI share a first common RI corresponding to a first common subset of the PDSCH layers, and a third and a fourth of the K PMIs (assuming K≥4) share a second common RI corresponding to a second common subset of the PDSCH layers), and wherein the first common subset of the PDSCH layers and the second common subset of the PDSCH layers are mutually exclusive, i.e., ┌K/2┐ RIs are reported. Under this embodiment, up to two CQIs are reported; one CQI is reported if the aggregate values across all RIs is no more than 4, and two CQIs otherwise. Up to 2 LI are reported, one for each codeword corresponding to a CQI.

In a third embodiment of the second set of embodiments, the CSI reporting configuration includes a grouping of the CSI-RS units into two groups of CSI-RS units, wherein members of a first of the two groups of CSI-RS units correspond to respective PMIs that are associated with the first of the two common subset of PDSCH layers, and wherein members of a second of the two groups of CSI-RS units correspond to respective PMIs that are associated with the second of the two common subset of PDSCH layers. The CSI-RS unit grouping may be RRC configured, MAC CE configured, or a combination thereof.

In a fourth embodiment of the second set of embodiments, the UE is configured with K CSI-RS units and is also expected to be configured with K tracking reference signals (“TRSs”), and wherein each of the K TRSs is QCLed with one of the K CSI-RS units. In one example, one TRS is QCLed with a one CSI-RS resource with QCL Type-A.

In a third set of embodiments, there may be CSI reporting.

In a first embodiment of the third set of embodiments, a UE reports within a CSI report an indication of one or more Doppler shift values corresponding to the CSI-RS units with respect to a reference CSI-RS unit, a tracking reference signal (e.g., an NZP CSI-RS resource configured with TRS information ‘trs-info’), or a combination thereof.

In a second embodiment of the third set of embodiments, the UE reports an indicator of a subset of the K CSI-RS units whose Doppler shift is within a pre-defined threshold from the reference Doppler shift value. In one example, an indicator of indices of a K′ subset of CSI-RS units out of the K CSI-RS units is reported, wherein K′≤K, using a combinatorial indicator (e.g., one combination out of (_{K}^{K′}) combinations using ┌log₂(_{K}^{K′})┐ bits), or using a bitmap of length K, wherein a value one corresponds to a port group whose Doppler shift value is within the threshold.

In a third embodiment of the third set of embodiments, the UE reports within the CSI report an indication of one or more average delay values corresponding to the CSI-RS ports with respect to a reference CSI-RS unit, or a tracking reference signal (e.g., an NZP CSI-RS resource configured with TRS information ‘trs-info’), or a combination thereof.

In a fourth embodiment of the third set of embodiments, the UE reports a CRI corresponding to one or more CSI-RS units. In one example, the CRI codepoints includes at least 2K−1 codepoints corresponding to all possible combinations of the K CSI-RS units.

In a fifth embodiment of the third set of embodiments, the UE reports an indicator of a subset of the K CSI-RS units whose average delay is within a pre-defined threshold from the reference average delay value. In one example, an indicator of indices of a K′ subset of CSI-RS units out of the K CSI-RS units is reported, wherein K′≤K, using a combinatorial indicator (e.g., one combination out of (_{K}^{K′}) combinations using ┌log₂(_{K}^{K′})┐ bits), or using a bitmap of length K, wherein a value one corresponds to a port group whose average delay value is within the threshold.

In a sixth embodiment of the third set of embodiments, the UE receives a higher-layer configuration including a common set of frequency domain basis indices corresponding to PMI. Alternatively, the UE reports the common set of frequency domain basis indices corresponding to PMI. The common set of PMI may be in a form of a range of FD basis indices (e.g., a contiguous window). The UE then reports an indication of a subset K′ of the K PMI corresponding to the K′ PMI whose PMI contribute to a largest CQI increase of the reported CQI.

In a seventh embodiment of the third set of embodiments, the CSI report includes a grouping of the CSI-RS units into two groups of CSI-RS units, wherein members of a first of the two groups of CSI-RS units correspond to respective PMIs that are associated with the first of the two common subset of PDSCH layers, and wherein members of a second of the two groups of CSI-RS units correspond to respective PMIs that are associated with the second of the two common subset of PDSCH layers.

In an eighth embodiment of the third set of embodiments, a PMI-specific scaling coefficient is reported for a subset of the PMI (e.g., K−1 PMIs), wherein the scaling coefficient includes at least an amplitude indicator whose value cannot exceed one, and a phase indicator, and wherein the scaling coefficient is common corresponding to a PMI is common for all coefficients corresponding to the respective PMI. An indicator of a strongest PMI is also reported as part of the CSI report, and no scaling coefficient is reported corresponding to the strongest PMI (e.g., the scaling coefficient is set to one by default). In one example, the scaling coefficient is drawn from a codebook with logarithmic values

$$( e . g . , \{ 1 , \frac{1}{\sqrt{2}} , \frac{1}{2} , \frac{1}{2 \sqrt{2}} , … \} ) .$$

In various embodiments, there may be K TCI states corresponding to CJT. In such embodiments, a UE configured with CJT transmission is associated with K CSI-RS resources where K≥2, the K CSI-RS resources are associated with K TCI states, the K TCI states indicate a QCL relationship with a same DMRS for PDSCH, and the K TCI states are indicated via a same TCI codepoint in a DCI that schedules PDSCH transmission (e.g., DCI Format 1_1 or DCI Format 1_2).

In certain embodiments, there may be CSI-RS resource allocation for K TRPs. In such embodiments, each of the multiple TRPs that jointly transmit to the UE are associated with a distinct NZP CSI-RS resource, wherein a plurality of CSI-RS resource groups is defined, and wherein the number of CSI-RS resource groups is proportional to (e.g., equal) the number of TCI states defined within the codepoint. In a first example, each of the CSI-RS resource groups includes a same number of NZP CSI-RS resources. In a second example, each of the K CSI-RS resource groups includes nk NZP CSI-RS resources, such that the total number of NZP CSI-RS resources matches a pre-defined number of CSI-RS resource groups N that is either configured or defined by a rule, such that n₁+n₂+ . . . +n_{K}=N. The CSI-RS resource groups are indicated via higher-layer signaling (e.g., based on MAC CE or RRC signaling).

In a fourth set of embodiments, there may be a CSI reporting configuration. In such embodiments, a CSI reporting configuration corresponding to CJT includes the K NZP CSI-RS resources configured for channel measurement and reporting. The CSI reporting configuration would configure the UE to report up to K PMIs, wherein each PMI corresponds to a distinct NZP CSI-RS resource.

In a first embodiment of the fourth set of embodiments, the CSI reporting configuration triggers the UE to report a CSI report including up to K PMI, one corresponding to each TRP, wherein each PMI includes a same number of layers indicated via a one RI corresponding to a common set of PDSCH layers, and wherein up to two CQIs are reported; one CQI is reported if the value indicated in the RI is no more than 4, and two CQIs otherwise. Up to 2 LI are reported, one for each codeword corresponding to a CQI.

In a second embodiment of the fourth set of embodiments, the CSI reporting configuration triggers the UE to report a CSI report including up to K PMI, one corresponding to each TRP, wherein each PMI includes a distinct number of layers indicated via up to K RIs corresponding to distinct PDSCH layers. In a first example, each PMI is associated with a distinct RI (e.g., one-to-one mapping between RI, PMI). In a second example, up to two PMI share a same RI (e.g., a first and a second of the K PMI share a first common RI corresponding to a first common subset of the PDSCH layers, and a third and a fourth of the K PMIs (assuming K≥4) share a second common RI corresponding to a second common subset of the PDSCH layers), and wherein the first common subset of the PDSCH layers and the second common subset of the PDSCH layers are mutually exclusive (e.g., ┌L/2┐ RIs are reported). Under this embodiment, up to two CQIs are reported; one CQI is reported if the aggregate values across all RIs is no more than 4, and two CQIs otherwise. Up to 2 LI are reported, one for each codeword corresponding to a CQI.

In a third embodiment of the fourth set of embodiments, the CSI reporting configuration includes a grouping of the NZP CSI-RS resources into two groups of NZP CSI-RS resources, wherein members of a first of the two groups of NZP CSI-RS resources correspond to respective PMIs that are associated with the first of the two common subset of PDSCH layers, and wherein members of a second of the two groups of NZP CSI-RS resources correspond to respective PMIs that are associated with the second of the two common subset of PDSCH layers. The CSI-RS resource grouping may be RRC configured, MAC CE configured, or a combination thereof.

In a fifth set of embodiments, there may be a PMI mapping and scaling. In such embodiments, there may be a mapping between at least two of the PMIs, the DMRS ports corresponding to PDSCH layers, and the CSI-RS resource groups. In a first example, the mapping is based on the CSI-RS resource ID associated with the PMI and the DMRS port ID. In a second example, the mapping is reported by the UE.

In a first embodiment of the fifth set of embodiments, a mapping between CSI-RS resource group ID and a DMRS port group, or a CDM group corresponding to a DMRS, or some combination thereof, is set by a rule (e.g., via antenna ports field in DCI for scheduling the PDSCH in DCI Format 1_1, or DCI Format 1_2, or both).

In a second embodiment of the fifth set of embodiments, a mapping between the CSI-RS resource group ID and a DMRS port group, or a CDM group corresponding to a DMRS, or some combination thereof, is configured (e.g., higher-layer configured as part of the PDSCH configuration such as via a PDSCH-Config information element (“IE”)).

In a third embodiment of the fifth set of embodiments, a PMI-specific scaling coefficient is reported for each PMI, wherein the scaling coefficient includes at least one of an amplitude indicator whose value cannot exceed one, and a phase indicator, and wherein the scaling coefficient corresponding to a PMI is common for all coefficients corresponding to the respective PMI. An indicator of a strongest PMI is reported as part of the CSI report, and no scaling coefficient is reported corresponding to the strongest PMI (e.g., the scaling coefficient is set to one by default).

In certain embodiments, there may be two TCI states corresponding to CJT. In such embodiments, a UE configured with CJT transmission is associated with up to two TCI states indicated in a TCI codepoint field within a DCI for scheduling PDSCH (e.g., DCI Format 1_1 or DCI Format 1_2), and each TCI state corresponds to a QCL relationship between a DMRS for PDSCH and at least one CSI-RS resource.

In a sixth set of embodiments, there may be a CSI-RS resource allocation for K TRPs.

In a first embodiment of the sixth set of embodiments, a CSI-RS resource associated with a TCI state that is reported within a TCI codepoint within the DCI for scheduling PDSCH is decomposed into two distinct groups of CSI-RS ports of the CSI-RS resource. In a first example, the CSI-RS resource including N CSI-RS ports is decomposed into two groups of N/2 exclusive CSI-RS ports, wherein each CSI-RS port group is associated with a distinct TRP. In a second example, a CSI-RS resource including N CSI-RS ports is decomposed into two groups of n₁, n₂ exclusive CSI-RS ports, wherein n₁+n₂=N. The CSI-RS port grouping is based on one or more of a pre-defined rule, and higher-layer signaling (e.g., based on MAC CE or RRC signaling). Each of the two groups of CSI-RS ports including the CSI-RS resource is QCLed with the DMRS ports. Under this embodiment, the DMRS ports may be implicitly associated with two distinct large-scale fading parameters corresponding to the two CSI-RS resource groups, similar to single frequency network (“SFN”) transmission. Only one CSI-RS port group may be selected.

In a second embodiment of the sixth set of embodiments, two CSI-RS resources are associated with a same TCI state that is reported within a TCI codepoint within the DCI for scheduling PDSCH, wherein the TCI state corresponds to a QCL relationship between the two CSI-RS resources and the DMRS for PDSCH. Under this embodiment, an NZP CSI-RS resource ID codepoint may correspond to the two NZP CSI-RS resources, wherein the DMRS ports may be implicitly associated with two distinct large-scale fading parameters corresponding to the two CSI-RS resource groups, similar to SFN transmission.

In a third embodiment of the sixth set of embodiments, the NZP CSI-RS resources are grouped into two groups of CSI-RS resources, wherein members of a first of the two groups of CSI-RS resources correspond to a first of the two TCI states, and wherein members of a second of the two groups of CSI-RS resources correspond to a second of the two TCI states. The CSI-RS resource grouping may be RRC configured, MAC CE configured, indicated by the UE in a CSI report, or some combination thereof.

In a seventh set of embodiments, there may be CSI reporting.

In a first embodiment of the seventh set of embodiments, the UE reports up to K PMIs to the network, wherein PMIs corresponding to one of a same CSI-RS resource, or two CSI-RS resources of the same group, correspond to a same RI, and a same set of PDSCH layers, DMRS ports, or both. On the other hand, PMIs corresponding to a different CSI-RS resource groups correspond to different RIs, and a different set of PDSCH layers, DMRS ports, or both.

In a second embodiment of the seventh set of embodiments, a PMI-specific scaling coefficient is reported for each PMI corresponding to a same CSI-RS resource group, wherein the scaling coefficient includes at least one of an amplitude indicator whose value cannot exceed one, and a phase indicator, and wherein the scaling coefficient is common corresponding to a PMI is common for all coefficients corresponding to the respective PMI. An indicator of a strongest PMI corresponding to a same CSI-RS resource group is also reported as part of the CSI report, and no scaling coefficient is reported corresponding to the strongest PMI (e.g., the scaling coefficient is set to one by default).

In certain embodiments, each TRP is associated with a distinct NZP CSI-RS resource. In such embodiments, all possible TCI codepoints may be indicated in a DCI for scheduling PDSCH (e.g., DCI Format 1_1, or DCI Format 1_2) as follows: 1) TCI codepoint corresponds to a single TCI state including one NZP CSI-RS resources in quasi-co-location (“QCL”) info: single-point transmission—1 PMI and 1 RI; 2) TCI codepoint corresponds to a single TCI state including an NZP CSI-RS resource ID codepoint in QCL info that corresponds to two NZP CSI-RS resources: CJT with 2 TRPs transmitting a common set of DMRS ports—2 PMI and one RI; 3) TCI codepoint corresponds to two TCI states, each including a single NZP CSI-RS resource in QCL info: NCJT with 2 TRPs transmitting a distinct set of DMRS ports—2 PMI and 2 RI; 4) TCI codepoint corresponds to two TCI states—a first TCI state comprising an NZP CSI-RS resource ID codepoint in QCL info that corresponds to two NZP CSI-RS resources, and a second TCI state comprising an NZP CSI-RS resource ID codepoint in QCL info that corresponds to a single NZP CSI-RS resource: CT with 2 TRPs (e.g., TRP A,B),jointly transmitting a common first set of DMRS ports—2 PMI and one RI AND a third TRP (e.g., TRP C) transmitting a distinct second set of DMRS ports—1 PMI and one RI; and 4) TCI codepoint corresponds to two TCI states, each including an NZP CSI-RS resource ID codepoint in QCL info that corresponds to two NZP CSI-RS resources: two TCI states with 2 CSI-RS resources each: CT with 2 TRPs (e.g., TRP A,B) transmitting a common first set of DMRS ports—2 PMI and one RI AND CJT with two other TRPs (e.g., TRP C,D) transmitting a common second set of DMRS ports—2 PMI and one RI.

In some embodiments, the terms antenna, panel, and antenna panel are used interchangeably. An antenna panel may be hardware that is used for transmitting and/or receiving radio signals at frequencies lower than 6 GHz (e.g., frequency range 1 (“FR1”)), or higher than 6 GHz (e.g., frequency range 2 (“FR2”) or millimeter wave (“mmWave”)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a UE antenna panel may be a physical or logical antenna array including a set of antenna elements or antenna ports that share a common or a significant portion of a radio frequency (“RF”) chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In certain embodiments, depending on a UE's own implementation, a “UE panel” may have at least one of the following functionalities as an operational role of unit of antenna group to control its transmit (“TX”) beam independently, unit of antenna group to control its transmission power independently, and/or unit of antenna group to control its transmission timing independently. The “UE panel” may be transparent to a gNB. For certain conditions, a gNB or network may assume that a mapping between a UE's physical antennas to the logical entity “UE panel” may not be changed. For example, a condition may include until the next update or report from UE or include a duration of time over which the gNB assumes there will be no change to mapping. A UE may report its UE capability with respect to the “UE panel” to the gNB or network. The UE capability may include at least the number of “UE panels.” In one embodiment, a UE may support UL transmission from one beam within a panel. With multiple panels, more than one beam (e.g., one beam per panel) may be used for UL transmission. In another embodiment, more than one beam per panel may be supported and/or used for UL transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qcl-Type may take one of the following values: 1)‘QCL-TypeA’: (Doppler shift, Doppler spread, average delay, delay spread); 2) ‘QCL-TypeB’: (Doppler shift, Doppler spread); 3) ‘QCL-TypeC’: (Doppler shift, average delay); and 4) ‘QCL-TypeD’: (Spatial Rx parameter). Other QCL-Types may be defined based on combination of one or large-scale properties.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mmWave, FR2, and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In certain embodiments, a transmission configuration indicator (“TCI”) state (“TCI-state”) associated with a target transmission may indicate parameters for configuring a quasi-co-location relationship between the target transmission (e.g., target RS of demodulation (“DM”) reference signal (“RS”) (“DM-RS”) ports of the target transmission during a transmission occasion) and a source reference signal (e.g., synchronization signal block (“SSB”), CSI-RS, and/or sounding reference signal (“SRS”)) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

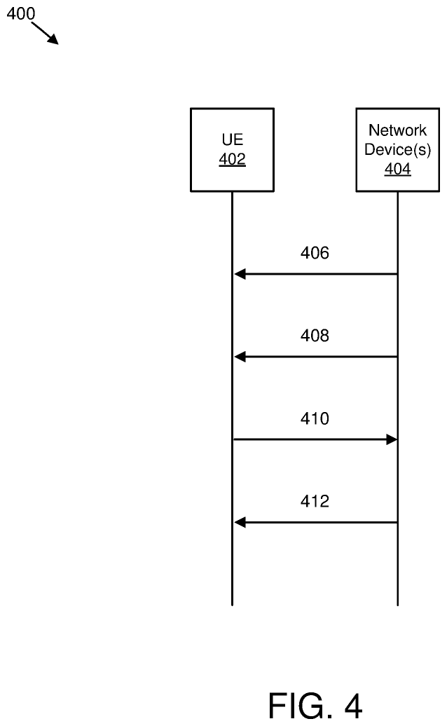

FIG. 4 is a schematic block diagram illustrating one embodiment of a system 400 for configuring a CSI report. The system 400 includes a UE 402 and one or more network devices 404. Each of the communications in the system 400 may include one or more messages.

In a first communication 406, the UE 402 receives a CSI reporting setting from the one or more network devices 404. In a second communication 408, the UE 402 receives a plurality of NZP CSI-RS resources for CMR from the one or more network devices 404. In a third communication 410, the UE 402 transmits a CSI report based on the received NZP CSI-RS resources to the one or more network devices 404. In a fourth communication 412, the UE 402 receives DCI for scheduling a PDSCH from the one or more network devices 404. The DCI includes a TCI field, a TCI state codepoint corresponding to the TCI field comprises a plurality of TCI states, and QCL information associated with each TCI state corresponds to a DMRS for PDSCH and a distinct set of NZP CSI-RS resources.

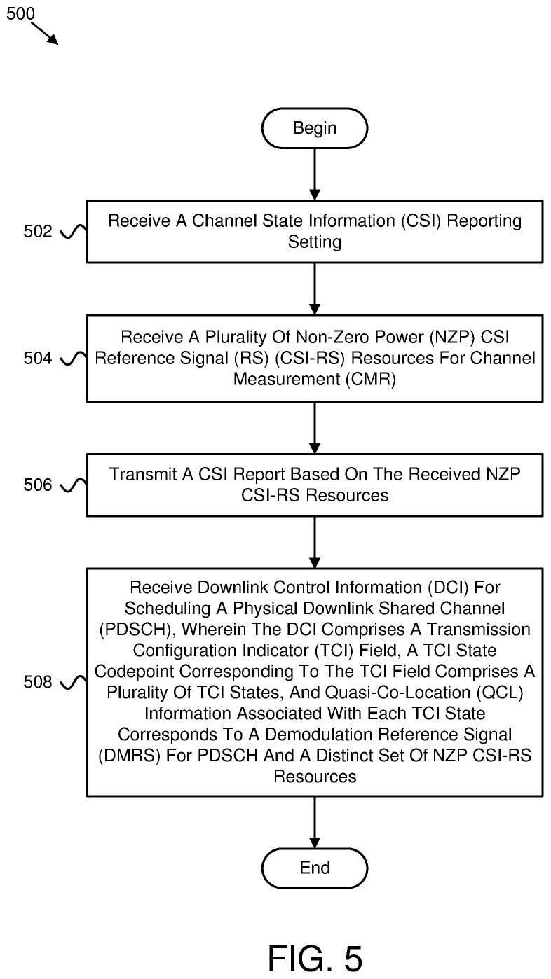

FIG. 5 is a flow chart diagram illustrating one embodiment of a method 500 for configuring a CSI report. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes receiving 502, at a UE, a CSI reporting setting. In some embodiments, the method 500 includes receiving 504 a plurality of NZP CSI-RS resources for CMR. In certain embodiments, the method 500 includes transmitting 506 a CSI report based on the received NZP CSI-RS resources. In various embodiments, the method 500 includes receiving 508 DCI for scheduling a PDSCH. The DCI includes a TCI field, a TCI state codepoint corresponding to the TCI field comprises a plurality of TCI states, and QCL information associated with each TCI state corresponds to a DMRS for PDSCH and a distinct set of NZP CSI-RS resources.

In certain embodiments, the plurality of NZP CSI-RS resources are grouped into multiple CSI-RS resource groups via a higher layer configuration. In some embodiments, the QCL information corresponding to each TCI state is associated with one or more CSI-RS resources from a distinct CSI-RS resource group. In various embodiments, the CSI report comprises a CRI, a subset of CRI codepoints correspond to at least one combination of the NZP CSI-RS resources, and each combination of the at least one combination comprises at most one NZP CSI-RS resource from a CSI-RS resource group of the multiple CSI-RS resource groups.

In one embodiment, a number of PMIs is reported in the CSI report corresponding to a number of NZP CSI-RS resources indicated in the CRI. In certain embodiments, ports of the DMRS for PDSCH are mapped with the NZP CSI-RS resources based on a corresponding CSI-RS resource group of the multiple CSI-RS resource groups, and the mapping is based on: a pre-defined rule; a higher-layer signaling for PDSCH configuration; or a combination thereof. In some embodiments, at least one NZP CSI-RS resource ID codepoint corresponds to a pair of NZP CSI-RS resources.

In various embodiments, the QCL information corresponding to the DMRS for PDSCH and the NZP CSI-RS resource comprises the codepoint corresponding to the pair of NZP CSI-RS resources. In one embodiment, the CSI reporting setting comprises up to two NZP CSI-RS resource IDs for channel measurement and reporting. In certain embodiments, the UE is configured with reporting at least one PMI and one RI corresponding to each NZP CSI-RS resource ID of the at least one NZP CSI-RS resource ID.

In some embodiments, at least one of the up to two NZP CSI-RS resource IDs comprises an NZP CSI-RS resource ID codepoint corresponding to a pair of NZP CSI-RS resources. In various embodiments, the method 500 further comprises reporting two PMIs corresponding to a same set of layers and one RI corresponding to the NZP CSI-RS resource ID codepoint corresponding to the pair of NZP CSI-RS resources. In one embodiment, the CSI report comprises a scaling coefficient corresponding to one PMI of the two PMIs corresponding to the NZP CSI-RS resource ID codepoint corresponding to the pair of NZP CSI-RS resources, and the scaling coefficient is in a form of an amplitude value.

In certain embodiments, the amplitude value is selected from a codebook of amplitude values with a logarithmic alphabet. In some embodiments, an indicator of a stronger PMI of the two PMIs is reported in the CSI report, and the amplitude value corresponding to the stronger PMI is set to one by default.

In various embodiments, each NZP CSI-RS resource of the plurality of NZP CSI-RS resources is associated with each TRP of a plurality of TRPs. In one embodiment, the PDSCH is associated with a PDSCH configuration that comprises a repetition scheme configuration, and the repetition scheme is set to a SDM scheme.

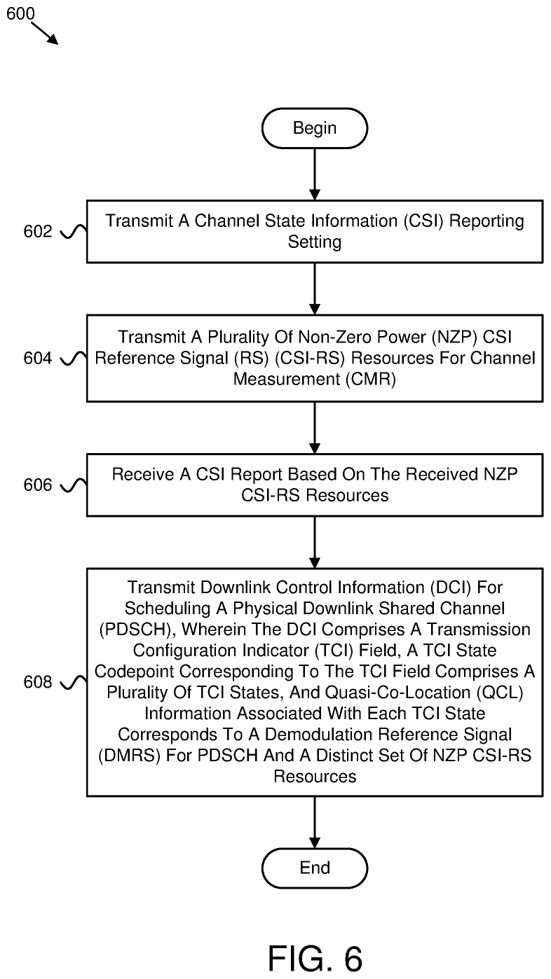

FIG. 6 is a flow chart diagram illustrating another embodiment of a method 600 for configuring a CSI report. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes transmitting 602, from at least one network device, a CSI reporting setting. In some embodiments, the method 600 includes transmitting 604 a plurality of NZP CSI-RS resources for CMR. In certain embodiments, the method 600 includes receiving 606 a CSI report based on the received NZP CSI-RS resources. In various embodiments, the method 600 includes transmitting 608 DCI for scheduling a PDSCH. The DCI includes a TCI field, a TCI state codepoint corresponding to the TCI field comprises a plurality of TCI states, and QCL information associated with each TCI state corresponds to a DMRS for PDSCH and a distinct set of NZP CSI-RS resources.

In certain embodiments, the plurality of NZP CSI-RS resources are grouped into multiple CSI-RS resource groups via a higher layer configuration. In some embodiments, the QCL information corresponding to each TCI state is associated with one or more CSI-RS resources from a distinct CSI-RS resource group. In various embodiments, the CSI report comprises a CRI, a subset of CRI codepoints correspond to at least one combination of the NZP CSI-RS resources, and each combination of the at least one combination comprises at most one NZP CSI-RS resource from a CSI-RS resource group of the multiple CSI-RS resource groups.

In one embodiment, a number of PMIs is reported in the CSI report corresponding to a number of NZP CSI-RS resources indicated in the CRI. In certain embodiments, ports of the DMRS for PDSCH are mapped with the NZP CSI-RS resources based on a corresponding CSI-RS resource group of the multiple CSI-RS resource groups, and the mapping is based on: a pre-defined rule; a higher-layer signaling for PDSCH configuration; or a combination thereof. In some embodiments, at least one NZP CSI-RS resource ID codepoint corresponds to a pair of NZP CSI-RS resources.

In various embodiments, the QCL information corresponding to the DMRS for PDSCH and the NZP CSI-RS resource comprises the codepoint corresponding to the pair of NZP CSI-RS resources. In one embodiment, the CSI reporting setting comprises up to two NZP CSI-RS resource IDs for channel measurement and reporting. In certain embodiments, the UE is configured with reporting at least one PMI and one RI corresponding to each NZP CSI-RS resource ID of the at least one NZP CSI-RS resource ID.

In some embodiments, at least one of the up to two NZP CSI-RS resource IDs comprises an NZP CSI-RS resource ID codepoint corresponding to a pair of NZP CSI-RS resources. In various embodiments, the method 600 further comprises receiving reporting comprising two PMIs corresponding to a same set of layers and one RI corresponding to the NZP CSI-RS resource ID codepoint corresponding to the pair of NZP CSI-RS resources. In one embodiment, the CSI report comprises a scaling coefficient corresponding to one PMI of the two PMIs corresponding to the NZP CSI-RS resource ID codepoint corresponding to the pair of NZP CSI-RS resources, and the scaling coefficient is in a form of an amplitude value.

In certain embodiments, the amplitude value is selected from a codebook of amplitude values with a logarithmic alphabet. In some embodiments, an indicator of a stronger PMI of the two PMIs is reported in the CSI report, and the amplitude value corresponding to the stronger PMI is set to one by default.

In various embodiments, each NZP CSI-RS resource of the plurality of NZP CSI-RS resources is associated with each TRP of a plurality of TRPs. In one embodiment, the PDSCH is associated with a PDSCH configuration that comprises a repetition scheme configuration, and the repetition scheme is set to a SDM scheme.

In one embodiment, an apparatus comprises a UE. The apparatus further comprises: a receiver that: receives a CSI reporting setting; and receives a plurality of NZP CSI-RS resources for CMR and a transmitter that transmits a CSI report based on the received NZP CSI-RS resources, wherein: the receiver receives DCI for scheduling a PDSCH, wherein the DCI comprises a TCI field, a TCI state codepoint corresponding to the TCI field comprises a plurality of TCI states, and QCL information associated with each TCI state corresponds to a DMRS for PDSCH and a distinct set of NZP CSI-RS resources.

In certain embodiments, the plurality of NZP CSI-RS resources are grouped into multiple CSI-RS resource groups via a higher layer configuration.

In some embodiments, the QCL information corresponding to each TCI state is associated with one or more CSI-RS resources from a distinct CSI-RS resource group.

In various embodiments, the CSI report comprises a CRI, a subset of CRI codepoints correspond to at least one combination of the NZP CSI-RS resources, and each combination of the at least one combination comprises at most one NZP CSI-RS resource from a CSI-RS resource group of the multiple CSI-RS resource groups.

In one embodiment, a number of PMIs is reported in the CSI report corresponding to a number of NZP CSI-RS resources indicated in the CRI.

In certain embodiments, ports of the DMRS for PDSCH are mapped with the NZP CSI-RS resources based on a corresponding CSI-RS resource group of the multiple CSI-RS resource groups, and the mapping is based on: a pre-defined rule; a higher-layer signaling for PDSCH configuration; or a combination thereof.

In some embodiments, at least one NZP CSI-RS resource ID codepoint corresponds to a pair of NZP CSI-RS resources.

In various embodiments, the QCL information corresponding to the DMRS for PDSCH and the NZP CSI-RS resource comprises the codepoint corresponding to the pair of NZP CSI-RS resources.

In one embodiment, the CSI reporting setting comprises up to two NZP CSI-RS resource IDs for channel measurement and reporting.

In certain embodiments, the UE is configured with reporting at least one PMI and one RI corresponding to each NZP CSI-RS resource ID of the at least one NZP CSI-RS resource ID.

In some embodiments, at least one of the up to two NZP CSI-RS resource IDs comprises an NZP CSI-RS resource ID codepoint corresponding to a pair of NZP CSI-RS resources.

In various embodiments, the transmitter reports two PMIs corresponding to a same set of layers and one RI corresponding to the NZP CSI-RS resource ID codepoint corresponding to the pair of NZP CSI-RS resources.

In one embodiment, the CSI report comprises a scaling coefficient corresponding to one PMI of the two PMIs corresponding to the NZP CSI-RS resource ID codepoint corresponding to the pair of NZP CSI-RS resources, and the scaling coefficient is in a form of an amplitude value.

In certain embodiments, the amplitude value is selected from a codebook of amplitude values with a logarithmic alphabet.

In some embodiments, an indicator of a stronger PMI of the two PMIs is reported in the CSI report, and the amplitude value corresponding to the stronger PMI is set to one by default.

In various embodiments, each NZP CSI-RS resource of the plurality of NZP CSI-RS resources is associated with each TRP of a plurality of TRPs.

In one embodiment, the PDSCH is associated with a PDSCH configuration that comprises a repetition scheme configuration, and the repetition scheme is set to a SDM scheme.

In one embodiment, a method of a UE comprises: receiving a CSI reporting setting; receiving a plurality of NZP CSI-RS resources for CMR; transmitting a CSI report based on the received NZP CSI-RS resources; and receiving DCI for scheduling a PDSCH, wherein the DCI comprises a TCI field, a TCI state codepoint corresponding to the TCI field comprises a plurality of TCI states, and QCL information associated with each TCI state corresponds to a DMRS for PDSCH and a distinct set of NZP CSI-RS resources.

In certain embodiments, the plurality of NZP CSI-RS resources are grouped into multiple CSI-RS resource groups via a higher layer configuration.

In some embodiments, the QCL information corresponding to each TCI state is associated with one or more CSI-RS resources from a distinct CSI-RS resource group.

In various embodiments, the CSI report comprises a CRI, a subset of CRI codepoints correspond to at least one combination of the NZP CSI-RS resources, and each combination of the at least one combination comprises at most one NZP CSI-RS resource from a CSI-RS resource group of the multiple CSI-RS resource groups.

In one embodiment, a number of PMIs is reported in the CSI report corresponding to a number of NZP CSI-RS resources indicated in the CRI.

In certain embodiments, ports of the DMRS for PDSCH are mapped with the NZP CSI-RS resources based on a corresponding CSI-RS resource group of the multiple CSI-RS resource groups, and the mapping is based on: a pre-defined rule; a higher-layer signaling for PDSCH configuration; or a combination thereof.

In some embodiments, at least one NZP CSI-RS resource ID codepoint corresponds to a pair of NZP CSI-RS resources.

In various embodiments, the QCL information corresponding to the DMRS for PDSCH and the NZP CSI-RS resource comprises the codepoint corresponding to the pair of NZP CSI-RS resources.

In one embodiment, the CSI reporting setting comprises up to two NZP CSI-RS resource IDs for channel measurement and reporting.

In certain embodiments, the UE is configured with reporting at least one PMI and one RI corresponding to each NZP CSI-RS resource ID of the at least one NZP CSI-RS resource ID.

In some embodiments, at least one of the up to two NZP CSI-RS resource IDs comprises an NZP CSI-RS resource ID codepoint corresponding to a pair of NZP CSI-RS resources.

In various embodiments, the method further comprises reporting two PMIs corresponding to a same set of layers and one RI corresponding to the NZP CSI-RS resource ID codepoint corresponding to the pair of NZP CSI-RS resources.

In one embodiment, the CSI report comprises a scaling coefficient corresponding to one PMI of the two PMIs corresponding to the NZP CSI-RS resource ID codepoint corresponding to the pair of NZP CSI-RS resources, and the scaling coefficient is in a form of an amplitude value.

In certain embodiments, the amplitude value is selected from a codebook of amplitude values with a logarithmic alphabet.

In some embodiments, an indicator of a stronger PMI of the two PMIs is reported in the CSI report, and the amplitude value corresponding to the stronger PMI is set to one by default.

In various embodiments, each NZP CSI-RS resource of the plurality of NZP CSI-RS resources is associated with each TRP of a plurality of TRPs.

In one embodiment, the PDSCH is associated with a PDSCH configuration that comprises a repetition scheme configuration, and the repetition scheme is set to a SDM scheme.

In one embodiment, an apparatus comprises at least one network device. The apparatus further comprises: a transmitter that: transmits a CSI reporting setting; and transmits a plurality of NZP CSI-RS resources for CMR; and a receiver that receives a CSI report based on the received NZP CSI-RS resources, wherein: the transmitter transmits DCI for scheduling a PDSCH, wherein the DCI comprises a TCI field, a TCI state codepoint corresponding to the TCI field comprises a plurality of TCI states, and QCL information associated with each TCI state corresponds to a DMRS for PDSCH and a distinct set of NZP CSI-RS resources.

In certain embodiments, the plurality of NZP CSI-RS resources are grouped into multiple CSI-RS resource groups via a higher layer configuration.

In some embodiments, the QCL information corresponding to each TCI state is associated with one or more CSI-RS resources from a distinct CSI-RS resource group.

In various embodiments, the CSI report comprises a CRI, a subset of CRI codepoints correspond to at least one combination of the NZP CSI-RS resources, and each combination of the at least one combination comprises at most one NZP CSI-RS resource from a CSI-RS resource group of the multiple CSI-RS resource groups.

In one embodiment, a number of PMIs is reported in the CSI report corresponding to a number of NZP CSI-RS resources indicated in the CRI.

In certain embodiments, ports of the DMRS for PDSCH are mapped with the NZP CSI-RS resources based on a corresponding CSI-RS resource group of the multiple CSI-RS resource groups, and the mapping is based on: a pre-defined rule; a higher-layer signaling for PDSCH configuration; or a combination thereof.

In some embodiments, at least one NZP CSI-RS resource ID codepoint corresponds to a pair of NZP CSI-RS resources.

In various embodiments, the QCL information corresponding to the DMRS for PDSCH and the NZP CSI-RS resource comprises the codepoint corresponding to the pair of NZP CSI-RS resources.

In one embodiment, the CSI reporting setting comprises up to two NZP CSI-RS resource IDs for channel measurement and reporting.

In certain embodiments, the UE is configured with reporting at least one PMI and one RI corresponding to each NZP CSI-RS resource ID of the at least one NZP CSI-RS resource ID.

In some embodiments, at least one of the up to two NZP CSI-RS resource IDs comprises an NZP CSI-RS resource ID codepoint corresponding to a pair of NZP CSI-RS resources.

In various embodiments, the receiver receives reports comprising two PMIs corresponding to a same set of layers and one RI corresponding to the NZP CSI-RS resource ID codepoint corresponding to the pair of NZP CSI-RS resources.

In one embodiment, the CSI report comprises a scaling coefficient corresponding to one PMI of the two PMIs corresponding to the NZP CSI-RS resource ID codepoint corresponding to the pair of NZP CSI-RS resources, and the scaling coefficient is in a form of an amplitude value.

In certain embodiments, the amplitude value is selected from a codebook of amplitude values with a logarithmic alphabet.

In some embodiments, an indicator of a stronger PMI of the two PMIs is reported in the CSI report, and the amplitude value corresponding to the stronger PMI is set to one by default.

In various embodiments, each NZP CSI-RS resource of the plurality of NZP CSI-RS resources is associated with each TRP of a plurality of TRPs.

In one embodiment, the PDSCH is associated with a PDSCH configuration that comprises a repetition scheme configuration, and the repetition scheme is set to a SDM scheme.

In one embodiment, a method of at least one network device comprising: transmitting a CSI reporting setting; transmitting a plurality of NZP CSI-RS resources for CMR; receiving a CSI report based on the received NZP CSI-RS resources; and transmitting DCI for scheduling a PDSCH, wherein the DCI comprises a TCI field, a TCI state codepoint corresponding to the TCI field comprises a plurality of TCI states, and QCL information associated with each TCI state corresponds to a DMRS for PDSCH and a distinct set of NZP CSI-RS resources.

In certain embodiments, the plurality of NZP CSI-RS resources are grouped into multiple CSI-RS resource groups via a higher layer configuration.

In some embodiments, the QCL information corresponding to each TCI state is associated with one or more CSI-RS resources from a distinct CSI-RS resource group.

In various embodiments, the CSI report comprises a CRI, a subset of CRI codepoints correspond to at least one combination of the NZP CSI-RS resources, and each combination of the at least one combination comprises at most one NZP CSI-RS resource from a CSI-RS resource group of the multiple CSI-RS resource groups.

In one embodiment, a number of PMIs is reported in the CSI report corresponding to a number of NZP CSI-RS resources indicated in the CRI.

In certain embodiments, ports of the DMRS for PDSCH are mapped with the NZP CSI-RS resources based on a corresponding CSI-RS resource group of the multiple CSI-RS resource groups, and the mapping is based on: a pre-defined rule; a higher-layer signaling for PDSCH configuration; or a combination thereof.

In some embodiments, at least one NZP CSI-RS resource ID codepoint corresponds to a pair of NZP CSI-RS resources.

In various embodiments, the QCL information corresponding to the DMRS for PDSCH and the NZP CSI-RS resource comprises the codepoint corresponding to the pair of NZP CSI-RS resources.

In one embodiment, the CSI reporting setting comprises up to two NZP CSI-RS resource IDs for channel measurement and reporting.

In certain embodiments, the UE is configured with reporting at least one PMI and one RI corresponding to each NZP CSI-RS resource ID of the at least one NZP CSI-RS resource ID.

In some embodiments, at least one of the up to two NZP CSI-RS resource IDs comprises an NZP CSI-RS resource ID codepoint corresponding to a pair of NZP CSI-RS resources.

In various embodiments, the method further comprises receiving reporting comprising two PMIs corresponding to a same set of layers and one RI corresponding to the NZP CSI-RS resource ID codepoint corresponding to the pair of NZP CSI-RS resources.

In one embodiment, the CSI report comprises a scaling coefficient corresponding to one PMI of the two PMIs corresponding to the NZP CSI-RS resource ID codepoint corresponding to the pair of NZP CSI-RS resources, and the scaling coefficient is in a form of an amplitude value.

In certain embodiments, the amplitude value is selected from a codebook of amplitude values with a logarithmic alphabet.

In some embodiments, an indicator of a stronger PMI of the two PMIs is reported in the CSI report, and the amplitude value corresponding to the stronger PMI is set to one by default.

In various embodiments, each NZP CSI-RS resource of the plurality of NZP CSI-RS resources is associated with each TRP of a plurality of TRPs.

In one embodiment, the PDSCH is associated with a PDSCH configuration that comprises a repetition scheme configuration, and the repetition scheme is set to a SDM scheme.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a channel state information (CSI) reporting setting;
receive a plurality of non-zero power (NZP) CSI reference signal (RS)(CSI-RS) resources for channel measurement (CMR);
transmit a CSI report based on the received NZP CSI-RS resources; and
receive downlink control information (DCI) for scheduling a physical downlink shared channel (PDSCH), wherein the DCI comprises a transmission configuration indicator (TCI) field, a TCI state codepoint corresponding to the TCI field comprises a plurality of TCI states, and quasi-co-location (QCL) information associated with each TCI state corresponds to a demodulation reference signal (DMRS) for PDSCH and a distinct set of NZP CSI-RS resources.

2. The UE of claim 1, wherein the plurality of NZP CSI-RS resources are grouped into multiple CSI-RS resource groups via a higher layer configuration.

3. The UE of claim 2, wherein the QCL information corresponding to each TCI state is associated with one or more CSI-RS resources from a distinct CSI-RS resource group.

4. The UE of claim 2, wherein the CSI report comprises a CSI-RS resource indicator (CRI), a subset of CRI codepoints correspond to at least one combination of the NZP CSI-RS resources, and each combination of the at least one combination comprises at most one NZP CSI-RS resource from a CSI-RS resource group of the multiple CSI-RS resource groups.

5. The UE of claim 4, wherein a number of precoder matrix indicators (PMIs) is reported in the CSI report corresponding to a number of NZP CSI-RS resources indicated in the CRI.

6. The UE of claim 2, wherein ports of the DMRS for PDSCH are mapped with the NZP CSI-RS resources based on a corresponding CSI-RS resource group of the multiple CSI-RS resource groups, and the mapping is based on:
a pre-defined rule;
a higher-layer signaling for PDSCH configuration;
or a combination thereof.

7. The UE of claim 1, wherein at least one NZP CSI-RS resource identifier (ID) codepoint corresponds to a pair of NZP CSI-RS resources.

8. The UE of claim 7, wherein the QCL information corresponding to the DMRS for PDSCH and the NZP CSI-RS resource comprises the codepoint corresponding to the pair of NZP CSI-RS resources.

9. The UE of claim 7, wherein the CSI reporting setting comprises up to two NZP CSI-RS resource IDs for channel measurement and reporting.

10. The UE of claim 9, wherein the UE is configured with reporting at least one PMI and one rank indicator (RI) corresponding to each NZP CSI-RS resource ID of the at least one NZP CSI-RS resource ID.

11. The UE of claim 9, wherein at least one of the up to two NZP CSI-RS resource IDs comprises an NZP CSI-RS resource ID codepoint corresponding to a pair of NZP CSI-RS resources.

12. The UE of claim 11, wherein the at least one processor is configured to cause the UE to report two PMIs corresponding to a same set of layers and one RI corresponding to the NZP CSI-RS resource ID codepoint corresponding to the pair of NZP CSI-RS resources.

13. The UE of claim 1, wherein each NZP CSI-RS resource of the plurality of NZP CSI-RS resources is associated with a network node of a plurality of network nodes.

14. A method performed by a user equipment (UE), the method comprising:
receiving a channel state information (CSI) reporting setting;
receiving a plurality of non-zero power (NZP) CSI reference signal (RS) (CSI-RS) resources for channel measurement (CMR);
transmitting a CSI report based on the received NZP CSI-RS resources; and
receiving downlink control information (DCI) for scheduling a physical downlink shared channel (PDSCH), wherein the DCI comprises a transmission configuration indicator (TCI) field, a TCI state codepoint corresponding to the TCI field comprises a plurality of TCI states, and quasi-co-location (QCL) information associated with each TCI state corresponds to a demodulation reference signal (DMRS) for PDSCH and a distinct set of NZP CSI-RS resources.

15. A base station, comprising:
at least one memory; and
at least one processor coupled with the at least one memory and configured to cause the base station to:
transmit a channel state information (CSI) reporting setting;
transmit a plurality of non-zero power (NZP) CSI reference signal (RS) (CSI-RS) resources for channel measurement (CMR);
receive a CSI report based on the received NZP CSI-RS resources; and
transmit downlink control information (DCI) for scheduling a physical downlink shared channel (PDSCH), wherein the DCI comprises a transmission configuration indicator (TCI) field, a TCI state codepoint corresponding to the TCI field comprises a plurality of TCI states, and quasi-co-location (QCL) information associated with each TCI state corresponds to a demodulation reference signal (DMRS) for PDSCH and a distinct set of NZP CSI-RS resources.

16. A processor for wireless communication, comprising:
at least one controller coupled with at least one memory and configured to cause the processor to:
receive a channel state information (CSI) reporting setting;
receive a plurality of non-zero power (NZP) CSI reference signal (RS)(CSI-RS) resources for channel measurement (CMR);
transmit a CSI report based on the received NZP CSI-RS resources; and
receive downlink control information (DCI) for scheduling a physical downlink shared channel (PDSCH), wherein the DCI comprises a transmission configuration indicator (TCI) field, a TCI state codepoint corresponding to the TCI field comprises a plurality of TCI states, and quasi-co-location (QCL) information associated with each TCI state corresponds to a demodulation reference signal (DMRS) for PDSCH and a distinct set of NZP CSI-RS resources.

17. The processor of claim 16, wherein the plurality of NZP CSI-RS resources are grouped into multiple CSI-RS resource groups via a higher layer configuration.

18. The processor of claim 17, wherein the QCL information corresponding to each TCI state is associated with one or more CSI-RS resources from a distinct CSI-RS resource group.

19. The processor of claim 17, wherein the CSI report comprises a CSI-RS resource indicator (CRI), a subset of CRI codepoints correspond to at least one combination of the NZP CSI-RS resources, and each combination of the at least one combination comprises at most one NZP CSI-RS resource from a CSI-RS resource group of the multiple CSI-RS resource groups.

20. The processor of claim 19, wherein a number of precoder matrix indicators (PMIs) is reported in the CSI report corresponding to a number of NZP CSI-RS resources indicated in the CRI.
